(19) United States
(12) Patent Application Publication
(10) Pub. No.: US 2020/0256316 A1
(43) Pub. Date: Aug. 13, 2020

(54) High-Speed Wind Power Generation Device

(71) Applicant: Richard Mooney, JR., Canonsburg, PA (US)

(72) Inventor: Richard Mooney, JR., Canonsburg, PA (US)

(21) Appl. No.: 16/273,060

(22) Filed: Feb. 11, 2019

(51) Int. Cl. F03D 9/12; F03D 3/04

(52) U.S. Cl. CPC F03D 9/12; F03D 3/0427

(57) ABSTRACT

The present invention provides a high-speed wind power generation device and method which converts wind into kinetic mechanical energy efficiently, consistently and with less attenuation of rotational speed than currently available. The high-speed rotation of the inventive device can be attributed to two factors: a curved wing assembly which increases wind flow, and the increased wind flow which hits the spaces between the curved wing assemblies to further increase rotation. Thus, a dual rotational force is created which increases rotational inertia which, in turn, attenuates the rate of rotational slowing, so that the device continues rotating at a high speed for an extended period of time if the wind abates or stops.

### FIELD OF THE INVENTION

This invention relates to a wind-driven energy generation device which converts wind into kinetic mechanical energy efficiently, consistently and with less attenuation of rotational speed than currently available.

### BACKGROUND OF THE INVENTION

Wind power has been used as long as humans have put sails into the wind. For more than two two-thousand years, wind-powered machines have ground grain and pumped water. The most common wind power system that comes to mind when one thinks of wind power is the windmill, as built by the Dutch in Holland to harness the winds off the English Channel, to pump water in and out of canals, and channels used for both transportation and irrigation.

Wind power, however, has been limited by at least two technical difficulties. One is variability of the wind. The second is overcoming frictional resistance that is inherent in all rotational systems.

There have been attempts to establish efficient wind power devices, but none has been widely commercialized due to their inability to deliver consistent and reliable wind power generation. U.S. Pat. No. 8,177,482 to Chuy-Nan Chio shows a wind power conversion apparatus driven by a fly wheel which requires a cumbersome long, hollow, tubular wind channel to direct wind through the flywheel. U.S. Pat. No. 4,037,983 to Poeta shows a wind motor but requires multiple rotating rotors rather than panel vanes which makes it more complicated and expensive. U.S. Pat. No. 1,568,718 to Brattland shows a series of rotating motors within a V-shaped conduit. All of these systems are complicated and energy-inefficient.

Thus, there is a need for extending the ability of wind-driven power generation equipment to generate power beyond the time when the wind has dropped below velocities sufficient to turn generators; to provide a wind power system that partially compensates for frictional resistance, and to provide a system that provides sustained power generation without the complexity and cost-constraints of current wind power generation systems.

### SUMMARY OF THE INVENTION

The present invention fulfills this need by providing a high-speed wind power generation device and method that converts wind into kinetic mechanical energy efficiently, consistently and with less attenuation of rotational speed than currently available. The device is comprised of a first circular plate and a second circular plate having a space therebetween. Each of the circular plates has an outer side, an inner side, a center opening therein, and one or more weights positioned on the first and second circular plates. Positioned in the space between the first and second plates are three “wing assemblies” comprised of an upper curved wing section, a cylindrical bar and a lower curved wing section. Each wing assembly is spaced 120 degrees apart and has a space therebetween from an adjacent wing assembly. Each of the wing assemblies are securely attached to a center, hollow cylindrical bar that is fitted within the center openings of the first and second circular plates. A rotating shaft is tightly fitted within the center, hollow cylindrical bar. Adjacent to each of the center openings on the outside of the first and second circular plates is a shaft collar, which secures the center, hollow cylindrical bar to the first and second circular plates.

The present invention also provides a method of producing power for a generator or energy storage device. The method comprises the steps of connecting the high-speed wind power generation device to a generator or energy storage device; having wind flow over the three wing assemblies and the three spaces therebetween so as to rotate the hollow, cylindrical bar with rotating shaft therein, having the generator or energy storage device capture the mechanical energy produced by the rotation of the device; and converting the mechanical energy to another form of energy.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a perspective view of the high-speed wind power generation device, in accordance with an embodiment of the invention;

FIG. is a front view of the high-speed wind power generation device, in accordance with an embodiment of the invention;

FIG. 3 is a perspective view of the high-speed wind power generation device showing the location of the center bar with rotating shaft therein, in accordance with an embodiment of the invention;

FIG. 4 is a closer perspective view of the high-speed wind power generation device, in accordance with an embodiment of the invention;

FIG. 5 is a cross-section of the high-speed wind power generation device taken along line 5-5 of FIG. 4, in accordance with an embodiment of the invention;

FIG. 6 is a perspective view of an alternate embodiment of the high-speed wind power generation device, in accordance with an embodiment of the invention;

FIG. 7 shows the high-speed wind power generation device in motion.

### DETAILED DESCRIPTION OF THE INVENTION

In the following detailed description, reference is made to the accompanying figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

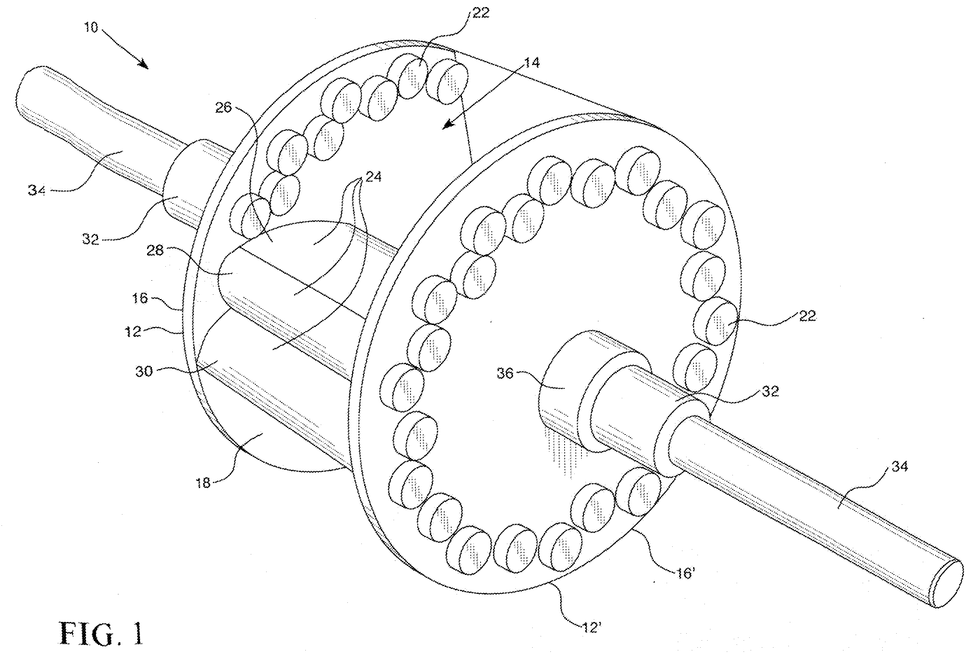

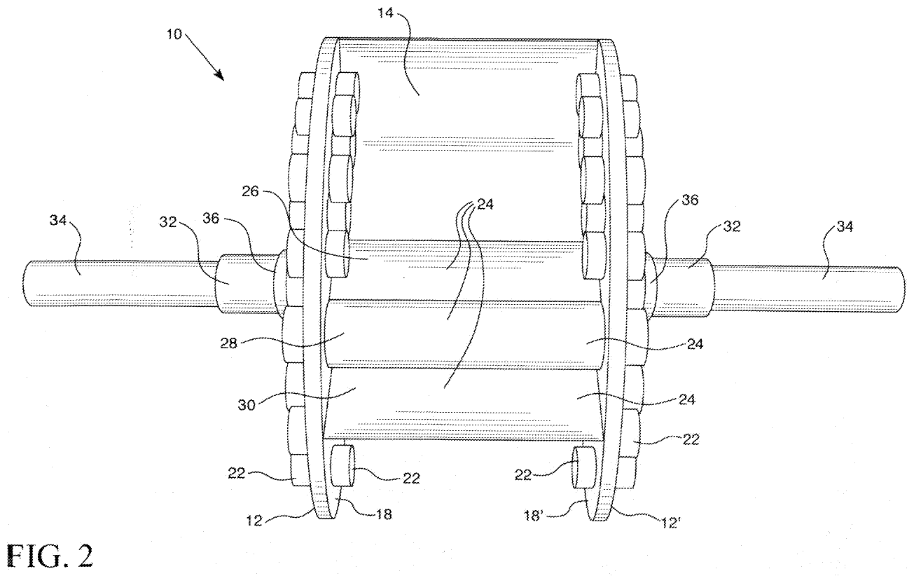

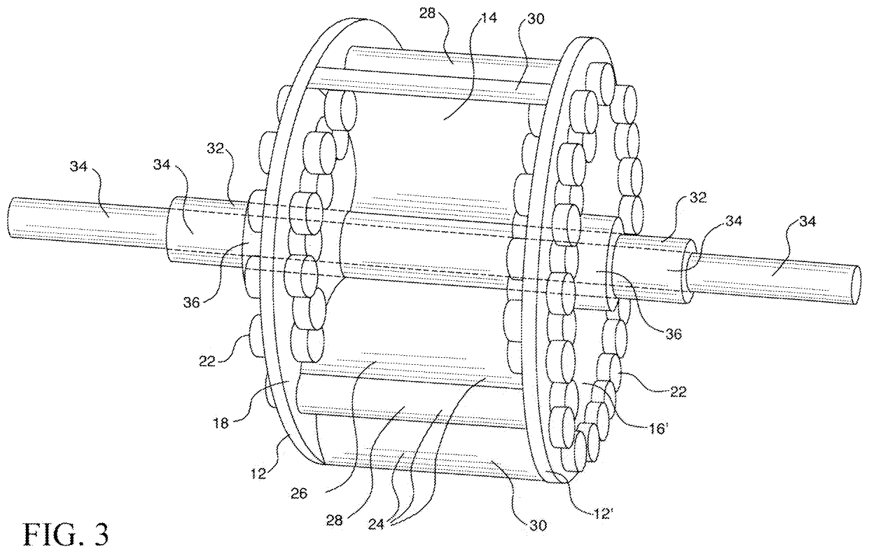

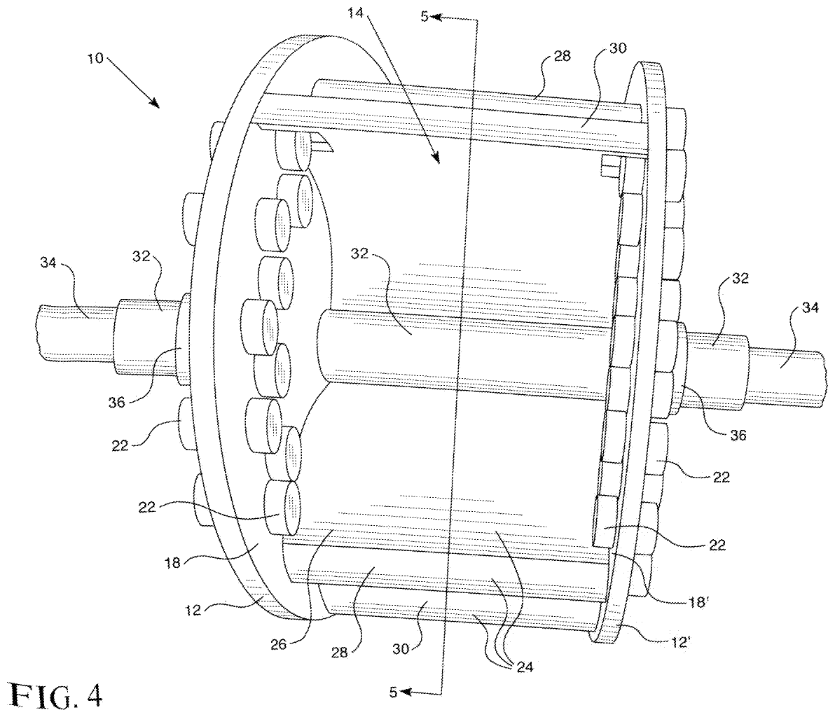

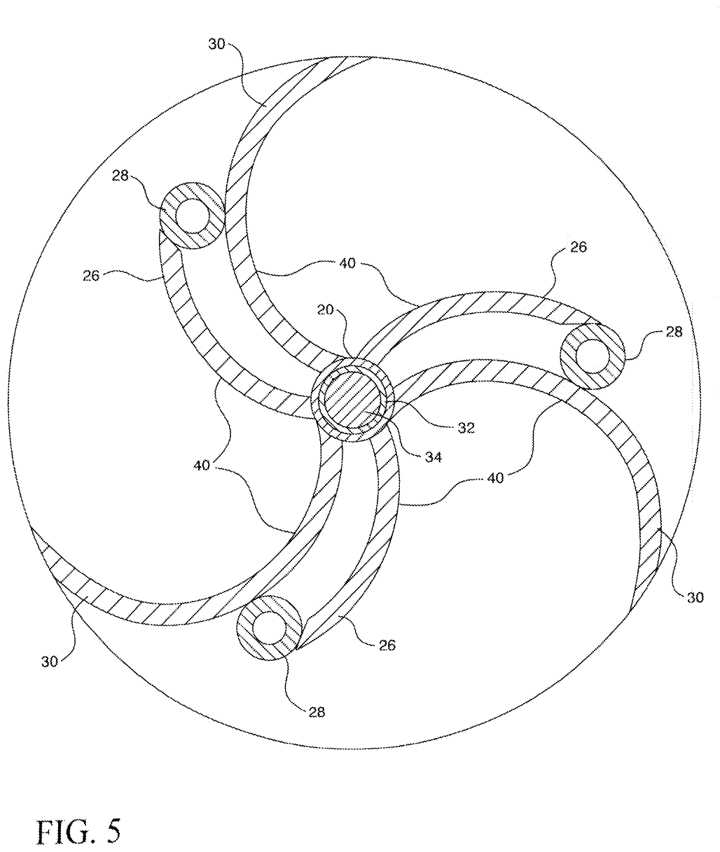

As shown in FIGS. 1-5, the high-speed wind power generation device includes a first circular plate 12 and a second circular plate 12′ having a space 14 therebetween. Each of the circular plates 12, 12′ has an outer side 16, 16′, an inner side 18, 18′, a center opening therein 20 (best seen in FIG. 5), and one or more weights 22 positioned on the first and second circular plates. Positioned in the space 14 between the first and second plates 12, 12′ are three “wing assemblies” 24 comprised of an upper curved wing section 26, a middle cylindrical bar 28 and a lower curved wing section 30. Each wing assembly 24 is spaced 120 degrees apart from an adjacent wing assembly 24, with spaces therebetween 40 (FIG. 5). Each of the wing assemblies 24 are securely attached to a center, hollow cylindrical bar 32 that is fitted within the center openings 20 of the first and second circular plates 12, 12′. A rotating shaft 34 is tightly fitted within the center, hollow cylindrical bar 34. Adjacent to each of the center openings 20 on the outside 16, 16′ of the first and second circular plates 12, 12′ is a shaft collar 36. The shaft collar 36 secures the center, hollow cylindrical bar 32 to the first and second circular plates 12, 12′.

As best seen in FIGS. 1 and 5, the upper curved wing section 26 is positioned atop and is curved over the middle cylindrical bar 28, and the lower curved wing section 30 is positioned below the middle cylindrical bar 28 and has the same curvature as the upper curved wing section 26 and the middle cylindrical bar 28.

One or more weights are located on the periphery of the inside and/or the outside of the first and second circular plates to increase inertial force and centrifugal energy. As shown in FIGS. 1-4 and 6, the weights 22 may be configured as small metal discs randomly attached to the periphery of the inside 16, 16′ and the outside 18, 18′ of the first and second circular plates 12, 12′. In another embodiment, the weights may be configured as a steel ring positioned on the periphery of the inside and/or outside of the circular plates (not shown).

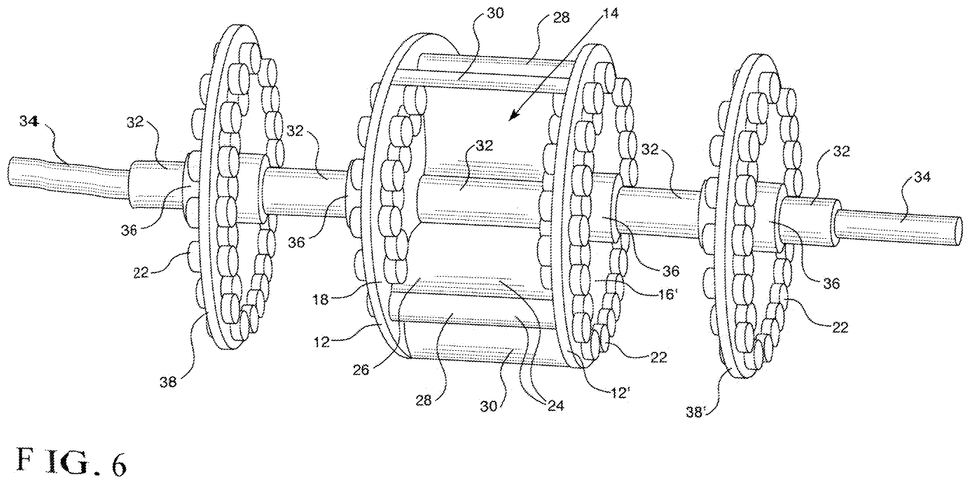

The high-speed wind power generation device also may include additional circular plates on either side of the first and second circular plates. As shown in FIG. 6, a third circular plate 38 is positioned near the outer side 18 of the first circular plate 12, and a fourth circular plate 38′ positioned near the outer side 18′ of the second circular plate 12′. The third and fourth circular plates 38, 38′ are identical in form to the first and second circular plates 12, 12′. The hollow cylindrical bar 32 inserts into the center openings of the third and fourth circular plates 38, 38′, and a shaft collar 36 fits around the center hollow cylindrical bar 32 for securement of the center hollow cylindrical bar 32 to the third and fourth circular plates 38, 38′.

The circular plates and curved wing assembly sections may be made from any suitable, light-weight plastic material, including, without limitation, high density polyethylene, ultra high molecular weight polyethylene, polyethylene terephthalate, polypropylene, polyvinyl chloride and the like.

The center, hollow cylindrical bar may be made from any suitable metal including, without limitation, steel, aluminum, copper, iron, lead, titanium and the like.

The invention contemplates that the curved wing assemblies are securely attached to the center, hollow cylindrical bar using, for example and without limitation, adhesives well known by those skilled in the art, such as steel reinforced epoxy glues and the like.

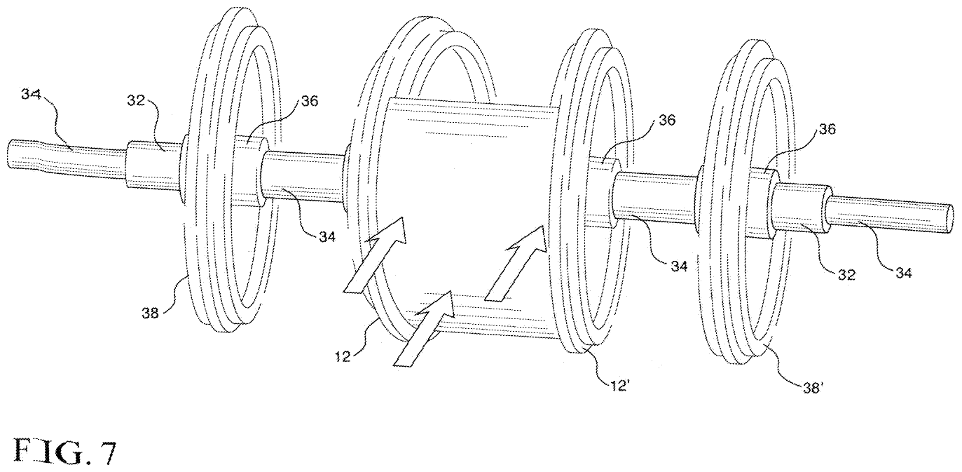

In motion, the center, hollow, cylindrical bar with rotating shaft therein rotates at the same speed and in the same direction as the three wing assemblies and circular plates. FIG. 7 shows the device in motion with additional circular plates attached. Speeds up to and exceeding 6000 rpms can be achieved due to the configuration of the three wing assemblies, and attenuation of these speeds is slow due to the inertial force contributed by the weighted circular plates. Specifically, when wind flows towards the device and hits a wing assembly to cause rotation of the device, the curvature of the wing assembly causes low pressure atop the curved wing assembly which causes the wind to flow faster towards the space between the wing assemblies, which further increases rotation of the device. Thus, the high-speed rotation of the inventive device is caused by two factors: the curved wing assembly which increases wind flow, and the increased wind flow that hits the space between the curved wing assemblies to further increase rotation. The dual rotational force that is thus created, along with the weighted circular plates, increases rotational inertia which, in turn, attenuates the rate of rotational slowing, so that the device continues rotating at a high speed for an extended period of time if the wind abates or stops.

In use, the rotating shaft is configured to connect with a mechanical shaft of a generator to capture the rotating shaft's mechanical energy and convert it to another form of energy. Alternatively, the rotating shaft may be connected to a mechanical shaft of an energy storage device.

It is contemplated that the high-speed wind power generation of the inventive device can be used to generate other forms of energy for use in transportation including, without limitation, energy to power automobiles, trucks, buses, boats, trains, airplanes or any other moving objects.

While the invention has been particularly shown and described with reference to embodiments described above, it will be understood by those skilled in the art that various alterations in form and detail may be made therein without departing from the spirit and scope of the invention, as defined by the appended claims.

What is claimed is:

1. A high-speed wind power generation device, comprising:
first circular plate and a second circular plate having a space therebetween, each of said circular plates having an outer side, an inner side, and a center opening therein;
one or more weights positioned on the first and second circular plates;
three wing assemblies perpendicular to and positioned in the space between the first and second plates, said three wing assemblies comprised of an upper curved wing section, a middle cylindrical bar and a lower curved wing section, each wing assembly spaced 120 degrees apart from an adjacent wing assembly with a space therebetween, and securely attached to a center hollow cylindrical bar fitted within the center openings of the first and the second circular plates;
a rotating shaft tightly fitted within the center hollow cylindrical bar; and
a shaft collar adjacent to each of the center openings on the outside of the first and the second circular plates, said shaft collar fitted around the center hollow cylindrical bar for securement of the center hollow cylindrical bar to the first and second circular plates.

2. The high-speed wind power generation device of claim 1, wherein the upper curved wing section is positioned atop and is curved over the middle cylindrical bar, and the lower curved wing section is positioned below the middle cylindrical bar and has the same curvature as the upper curved wing section and the middle cylindrical bar.

3. The high-speed wind power generation device of claim 1, wherein the one or more weights is located on the periphery of the inside and the outside of the first and second circular plates.

4. The high-speed wind power generation device of claim 1, wherein the one or more weights is located on the periphery of the outside of the first and second circular plates.

5. The high-speed wind power generation device of claim 1, wherein the one or more weights is comprised of a steel ring located on the periphery of the outside of the first and second. circular plates.

6. The high-speed wind power generation device of claim 1, further comprising a third circular plate positioned near the outer side of the first circular plate, and a fourth circular plate positioned near the outer side of the second circular plate, said third and fourth circular plates each having an outer side, an inner side and a center opening therein and one or more weights positioned thereon, wherein the center, hollow cylindrical bar inserts into the center openings of the third and fourth circular plates, and wherein a shaft collar fits around the center hollow cylindrical bar for securement of the center hollow cylindrical bar to the third and fourth circular plates.

7. The high-speed wind power generation device of claim 1, wherein the center, hollow, cylindrical bar with rotating shaft therein rotate at the same speed and in the same direction as the three wing assemblies and first and second circular plates.

8. The high-speed wind power generation device of claim 1, wherein the rotating shaft is configured to connect with a power generator to capture its rotational power.

9. A method of producing mechanical power for a generator or energy storage device, comprising:
connecting the high-speed wind power generation device of claim 1 to a generator or energy storage device;
having wind flow over the three wing assemblies and three spaces therebetween so as to rotate the hollow, cylindrical bar with rotating shaft therein; and
having the generator or energy storage device capture the mechanical energy produced by the rotation of the device and convert the mechanical energy to another form of energy.

10. The method of claim 9, wherein rotation of the device can achieve speeds ranging from about 3000 to about 6000 rpms.
